(19) United States
(12) Patent Application Publication
(10) Pub. No.: US 2013/0299408 A1
(43) Pub. Date: Nov. 14, 2013

(54) FILTRATION UNIT AND SYSTEM

(71) Applicants: Marina Olenberg, Kiryat Shmona (IL); Boaz Zur, DN Bikat Beit Hakerem (IL); Ron Tal, D.N. Galil Elyon (IL); Gonen Eshel, DN Galil Elyon (IL)

(72) Inventors: Marina Olenberg, Kiryat Shmona (IL); Boaz Zur, DN Bikat Beit Hakerem (IL); Ron Tal, D.N. Galil Elyon (IL); Gonen Eshel, DN Galil Elyon (IL)

(73) Assignee: AMIAD WATER SYSTEMS LTD., D.N. Upper Galil 1 (IL)

(21) Appl. No.: 13/878,006

(22) PCT Filed: Oct. 6, 2011
(86) PCT No.: PCT/IL11/00782

§ 371 Date: Apr. 5, 2013

Related U.S. Application Data
(60) Provisional application No. 61/390,734, filed on Oct. 7, 2010.

(51) Int. Cl. B01D 33/23; B01D 33/46

(52) U.S. Cl. CPC B01D 33/23; B01D 33/463
USPC 210/232; 210/486; 210/345; 210/332; 210/327

(57) ABSTRACT

Provided is a filtration cassette having a rigid body configured for externally supporting a filtration media disposed thereover and having at least one filtering surface configured with a flow path facilitating filtered fluid flow from a space extending between the filtration media and the filtering surface, and extending towards an outlet terminal. Also provided is a filtration segment including such a filtration cassette and where the filtration media is a filtration thread tensionally coiled over the filtration cassette at a multi-layered and tight configuration. Further provided are a plurality of such filtration segments which are configured into a disk-type assembly forming a filtration unit for a filtering system.

### FIELD OF THE PRESENT DISCLOSED SUBJECT MATTER

The present disclosed subject matter relates to filtration units and filtration systems making use of same. The present disclosure is further concerned with a filtration method using filtration units and filtration systems of the specified type, and methods for rinsing the filtration units.

### BACKGROUND OF THE PRESENT DISCLOSED SUBJECT MATTER

Disk filters, at times referred to also as plate filters, are well known and are in use for many years.

A disk filter system typically comprises a plurality of parallely disposed discs, each composed of a plurality of filtering segments (sectorial segments, trapezoidal segments, or otherwise shaped), coupled together to form a disk-shaped filtration element.

Examples of disk filters are disclosed in Canadian Patent publication CA 2510282A disclosing a filter sector for a disc filter, said sector having a root and a tip with a plurality of radial supports extending there between, each of said supports having a channel section with opposed walls diverging said tip to said root, said radial supports being interconnected by lateral members to define a pair of oppositely directed faces to support a filter membrane.

A further disk system is disclosed in WO 2006/084858 directed to a static plate filter with a continuous flow for the filtering of liquids comprising a set of static filtrating plates with a filtering fabric, a central fissured tube with a cavity section for the evacuation of the filtered liquid, a waterproof aspiration chamber, a rotating cleaning device for the regeneration of the plates, with a header which rotates around the aspiration chamber with which it is in direct contact, on which are coupled fissured tubes for the cleaning and aspiration of the filtering fabric, where the fissured tubes of the rotating cleaning device stick to the filtering fabric and their position in such that it guarantees the cleaning of the adjacent faces of two near plates.

A particular filtering media is disclosed in an article entitled [Real World Performance and Low Cost Operation Maximizes Benefits of Disc-Type Filtration], by Siemens Water Technologies, available at:

http://www.water.siemens.com/SiteCollectionDocuments/Product_Lines/Davis_Products/Brochures/BC-FORTYX3-BR-0809.pdf (last accessed on Sep. 29, 2011).

### SUMMARY OF THE PRESENT DISCLOSED SUBJECT MATTER

Filters in accordance with the disclosed subject matter can be used for filtering different fluid media, including gaseous material and different liquids such as fresh water, irrigation water, contaminated water including sewage, emulsions, sea water, viscous liquids, with the range of fluid pressure and other parameters thereof being substantially unlimited.

The term fluid is thus defined hereinafter as any flowable matter, i.e. gas or liquid, regardless its purpose, degree of contamination, particle size, viscosity, pressure or any other parameters. Hence, herein in the specification and claims the term fluid is used in its broadest sense.

It is an object of the present disclosed subject matter to provide a filtering segment and a filtration cassette therefore, for use in conjunction with a disk-type filtration system.

It is another object of the present disclosed subject matter to provide a disk-type filtration system configured with filtration segments according to the present disclosed subject matter.

It is yet an object of the present disclosed subject matter to provide a rinsing system for a disk-type filtration system.

A filtration segment according to the disclosed subject matter comprises a filtration cassette configured as a rigid body externally supporting a filtration media disposed thereover and having at least one filtering surface configured with a flow path facilitating filtered fluid flow from a space extending between the filtration media and the filtering surface, and extending towards an outlet terminal.

The filtration media, according to a particular design is a thread tensionally coiled (wrapped) over the filtration cassette unit at a multi-layered and tight configuration. The thread is substantially continuous. The tension of the coiled (wrapped) thread can vary about the longitudinal axis of the filtration cassette and/or between wrapping layers. The filtration media can be composed of a thread, continuous or not, with an altering thickness.

According to an embodiment of the disclosed subject matter, the thread filter media is wrapped about a longitudinal axis of the filtration cassette.

The filtration cassette, according to one particular configuration, is a flat, trapezoidal structure, such that an array of like filtration cassettes can be assembled into a near-to-circular, disc-like filtering assembly.

The filtering surface is configured with a plurality of ribs projecting from the surface for supporting the filtration media and facilitating fluid flow through the flow path, over the surface and between the plurality of ribs. The flow path extends over the filtering surface of the filtration cassette and then extends into a collecting duct within the rigid body (through the filtering surface) and further towards the outlet terminal.

The filtration cassette is configured for assembly in a radial setup to a filtered fluid collecting duct. Coupling to the collecting duct is facilitated through a coupler of the outlet terminal (which according to a particular design extends along the longitudinal axis of the filtration cassette), configured for articulation to the collecting duct and being in flow communication therewith, wherein assembly of such filtration cassettes in a juxtaposing configuration gives rise to the disc-like filtering system.

The coupler can be tubular member configured for press-fit into a corresponding receptacle at the fluid collecting duct, in fluid tight fashion.

The filtering surface can be flat or can be configured with a concaved cross-section. A centerline of the concavity extending substantially parallel to the longitudinal axis of the filtration cassette.

The filtration cassette can be made of a plastic molded material with both filtration surfaces being substantially same.

The filtration cassette is configured at a distal end thereof with an arresting portion for securing at an assembled position to thereby prevent spontaneous detaching from a collecting duct of a filtration system. The arresting portion can be in the form of a band-receiving groove configured at a rear end of the filtration cassette.

According to yet an aspect of the disclosed subject matter there is provided a disk-like filtering unit configured with an array of filtration segments of the aforementioned type, said filtration segments being coupled into a filtered fluid collecting duct of the filtering system for providing filtered fluid. Further there is provided a rinsing mechanism for rinsing the filtration cassettes.

Filtration segments of a filtering unit are secured to thereby prevent their spontaneous detaching from the collecting duct. Securing can be configured by a band radially packing the filtration segments, or by a coupler arrangement between neighboring filtration segments.

According to a particular design, the filtering system comprises a plurality of parallely extending fluid jet emitting arms, with at least one jet emitting nozzle juxtaposing and facing a filtration media of a filtration cassettes of the disk-like filtering units, and configured for selectively emitting a jet of rinsing fluid over the filtration media.

A rinsing mechanism according to the disclosed subject matter, for a disk-type filtration system, comprises at least one fluid jet emitting arm juxtaposed and facing a filtration media of a filtration cassette, and configured for selectively emitting a jet of rinsing fluid over the filtration media. According to one example the at least one jet emitting arm is fitted with an array of jet nozzles disposed along its length and facing the filtration media, and whereby disc-like filtering units are rotationally displaceable about a central axis thereof, whereby a rinsing fluid jet is applied substantially over the entire surface of the filtration media as they rotate with respect to the jet emitting arms.

According to another configuration, the rinsing mechanism comprises one or more jet emitting arms, each fitted with one or more jet nozzles near a distal end of the one or more arms and wherein the arms are configured for reciprocal pivotal displacement (in a turntable-arm resembling fashion) over the filtration media of the disc-like filtering units, and whereby the disc-like filtering units are rotationally displaceable about a central axis thereof, whereby a rinsing fluid let emitted from the jet nozzles substantially rinses an entire face of a filtration segment. According to a particular design, the jet emitting arms are pivotally disposed near a periphery of the filtration cassettes.

Rotation of the disc-like array of disc-like filtering units and/or manipulating motion of the one or jet emitting rinsing arms of the rinsing mechanism is facilitated by any type of motion generating mechanism, such as an electric motor, a hydraulic motor, pneumatic actuators, etc., and combinations thereof

### BRIEF DESCRIPTION OF THE DRAWINGS

In order to understand the present disclosed subject matter and to see how it may be carried out in practice, embodiments will now be described, by way of non-limiting examples only, with reference to the accompanying drawings, in which:

FIG. 1A is a planar view of a filtration segment in accordance with the first aspect of the present disclosed subject matter;

FIG. 1B is a front perspective view of a filtration cassette unit used in the filtration segment of FIG. 1A;

FIG. 1C is a rear perspective view of FIG. 1B;

FIG. 1D is a top planar view of FIG. 1B;

FIG. 2A is a section along line I-I in FIG. 1C;

FIG. 2B is a section along line II-II in FIG. 1C;

FIG. 2C is a longitudinal section along line in FIG. 1C;

FIG. 3A is a longitudinal section along line V-V in FIG. 1A;

FIG. 3B is an enlargement of the portion marked B in FIG. 3A;

FIG. 3C is a sectioned view at enlarged scale, of a portion taken along line IV-IV in FIG. 1A;

FIG. 4 is a perspective view of a disk-like filtering unit composed of a plurality of filtration segments seen in FIG. 1A;

FIG. 5A is a front perspective view of a filtering system in accordance with a configuration of the present disclosed subject matter;

FIG. 5B is a rear perspective view of FIG. 5A;

FIG. 6A illustrates the filtering tem of FIGS. 5A and 5B with several components removed for clarification;

FIG. 6B illustrates the filtering unit of FIGS. 5A and 5B with disk-like filtering units removed for clarification;

FIG. 6C is an exploded view of the filtering system of FIGS. 5A and 5B;

FIG. 7 is a rinsing mechanism in accordance with an example of the present disclosed subject matter, suitable for use with a filtering system of the disclosed subject matter;

FIGS. 8A to 8F illustrate different views and close-ups of a filtration assembly accommodating a filtering system in accordance with an example of the disclosed subject matter, wherein:

FIG. 8A is a perspective, partially cutout view of the filtration assembly;

FIG. 8B is an enlargement of the portion marked B in FIG. 8A;

FIG. 8C is a schematic end view of the filtration assembly;

FIG. 8D an enlargement of the portion marked D in FIG. 8C;

FIG. 8E is a view of the filtration assembly illustrating fluid flow scheme;

FIG. 8F is an exploded view of the filtration unit and rinsing mechanism;

FIG. 9 is a perspective view of a rinsing mechanism in accordance with a different example, for use in conjunction with a filtering system in accordance with the disclosed subject matter;

FIG. 10A is a perspective view of a rinsing mechanism in accordance with the example of FIG. 9, with its left support mechanism removed for clarification;

FIG. 10B is a bottom perspective view of FIG. 10A;

FIG. 10C is a section along line X-X in FIG. 10A; and

FIG. 10D is a perspective view of the rinsing mechanism of FIG. 10A, sectioned along inclined line XI-XI in FIG. 10A.

### DETAILED DESCRIPTION OF EMBODIMENTS

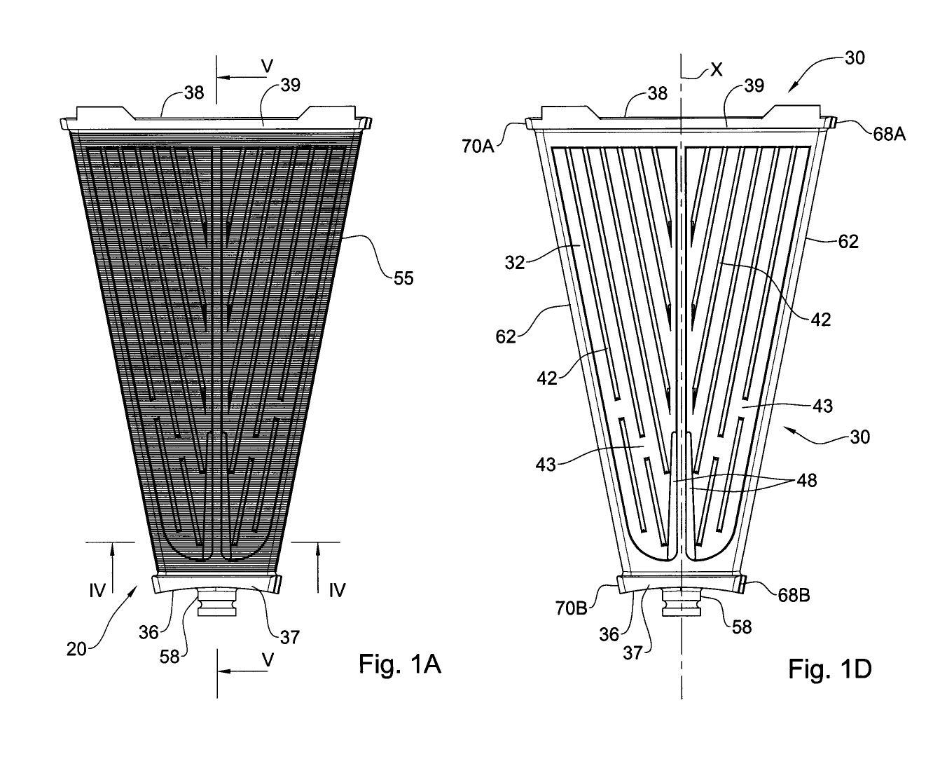

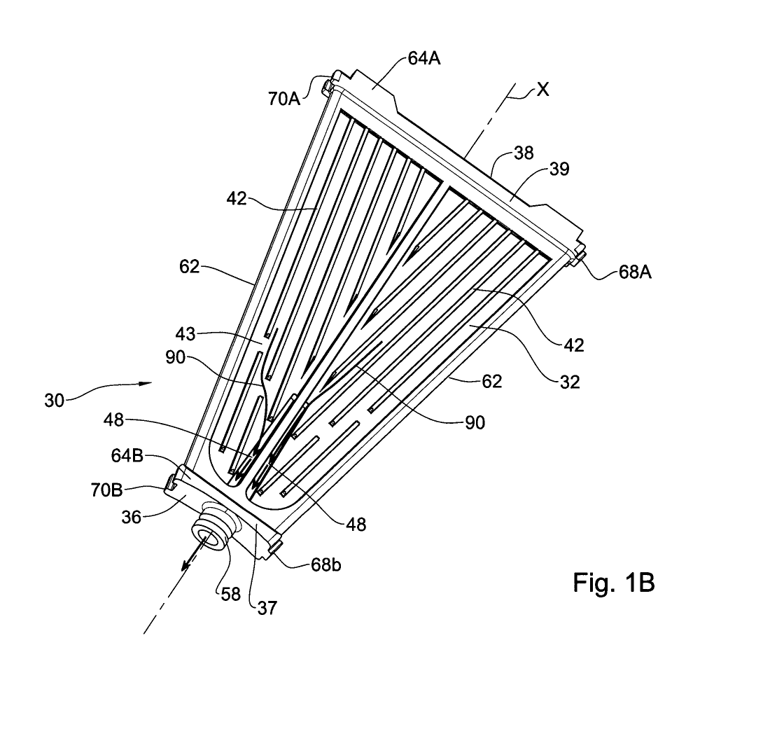

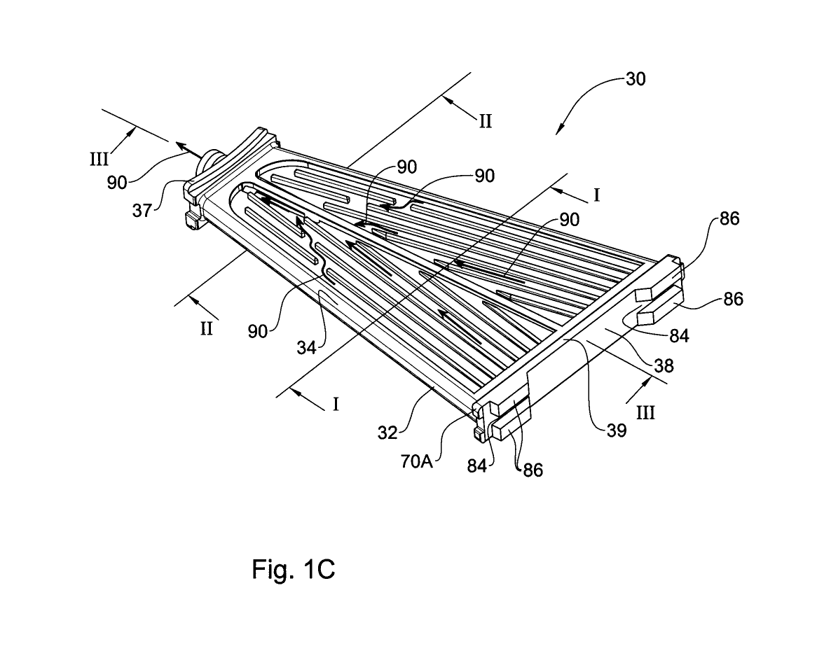

In FIG. 1A of the drawings there is illustrated a filtration segment generally designated 20, in accordance with a first aspect of the present disclosed subject matter, useful as a filtering component in a filtering unit in accordance with further aspects of the present disclosed subject matter, and as will be discussed hereinafter in further detail.

The filtration segment 20 comprises a filtration cassette 30 seen in further detail in FIGS. 1B to 1D, 2A to 2C and 3A to 3C. The filtration cassette 30 is a substantially flat, trapezoidal structure which in the present example is a plastic molded article and is thus durable and light weight. The filtration cassette 30 comprises a top filtering surface 32 and a bottom filtering surface 34 extending between a narrow, front base 36 and a wider, rear (distal) base 38, and defining together a trapezoidal shape extending about a longitudinal axis X. The structure of the filtration cassette 30 is reinforced by laterally exuding end portions 37 (at the front end) and 39 (at the rear end), rendering the structure twist resistance and bending resistance, and further serving to pack the thread filtering media, as illustrated in FIG. 1A.

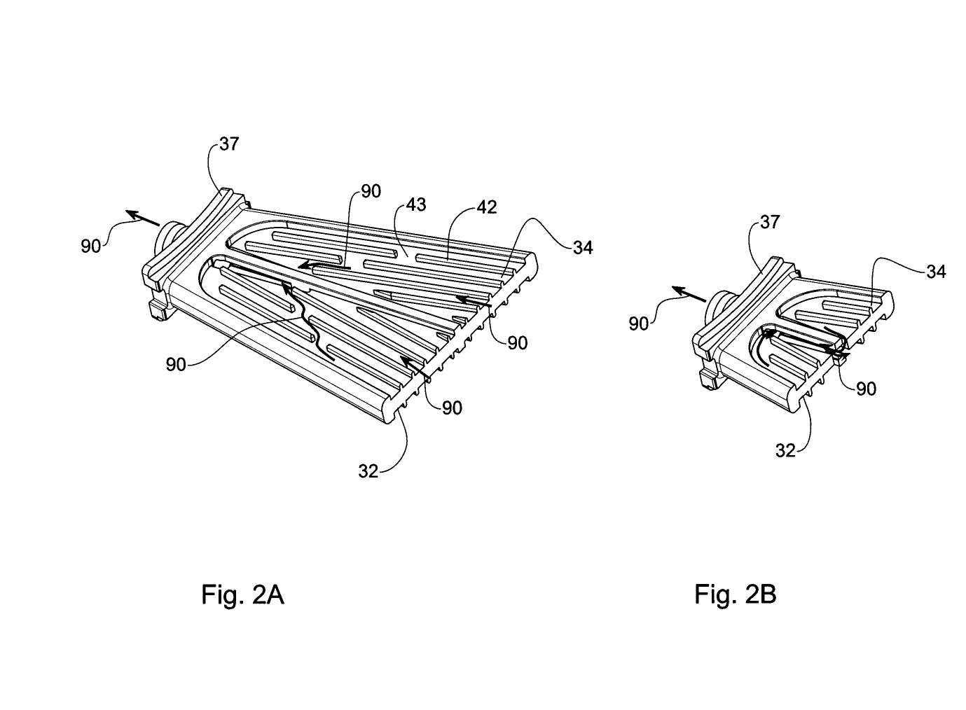

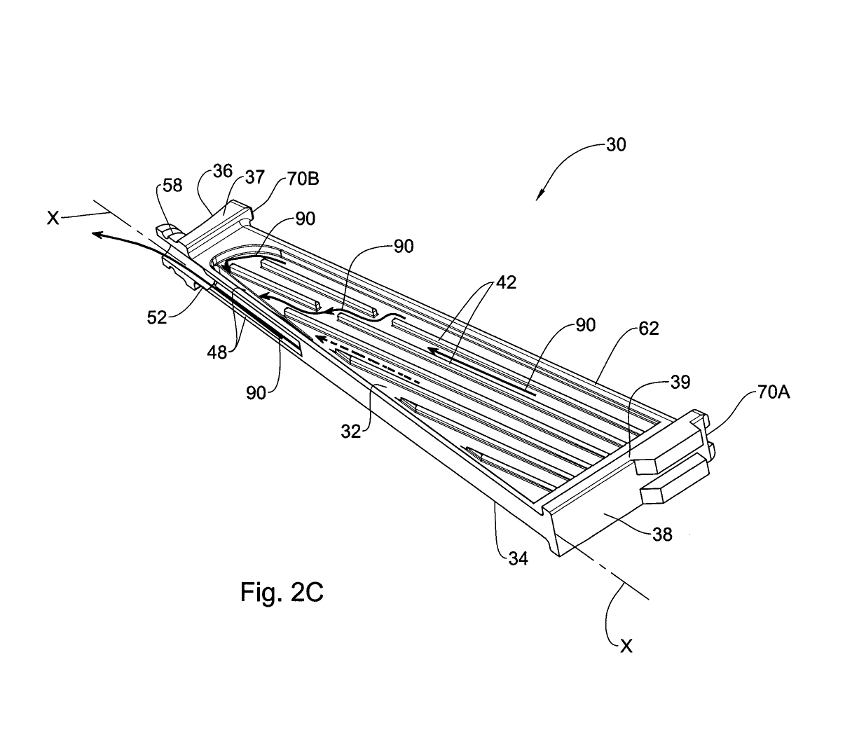

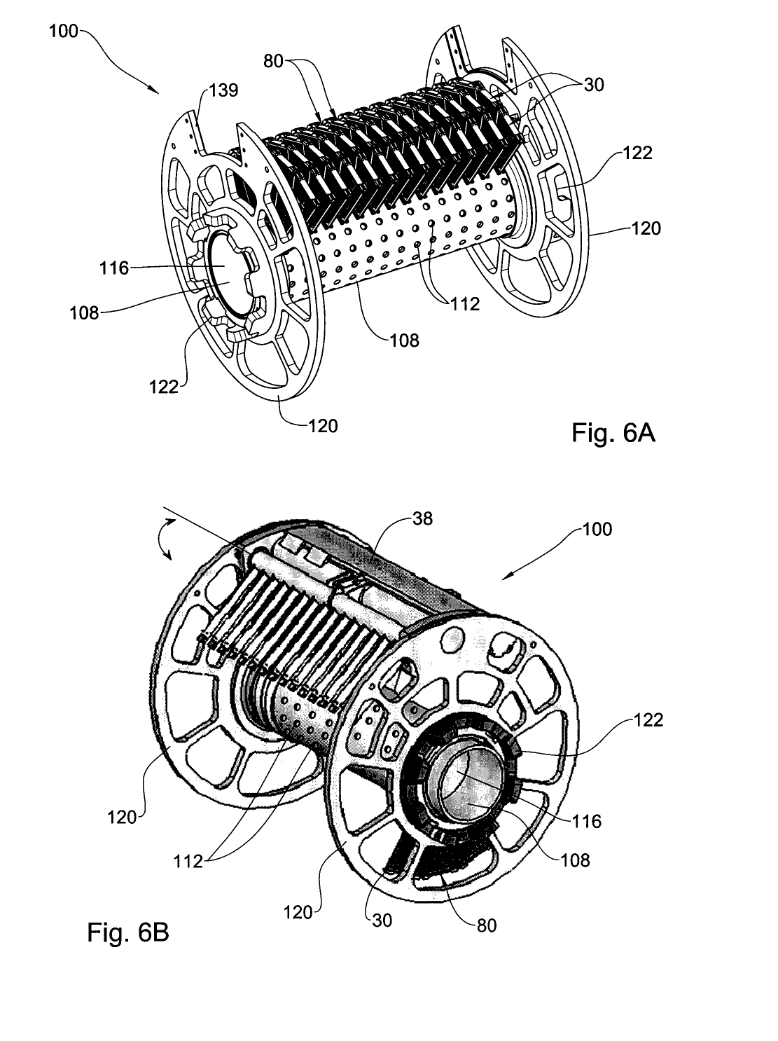

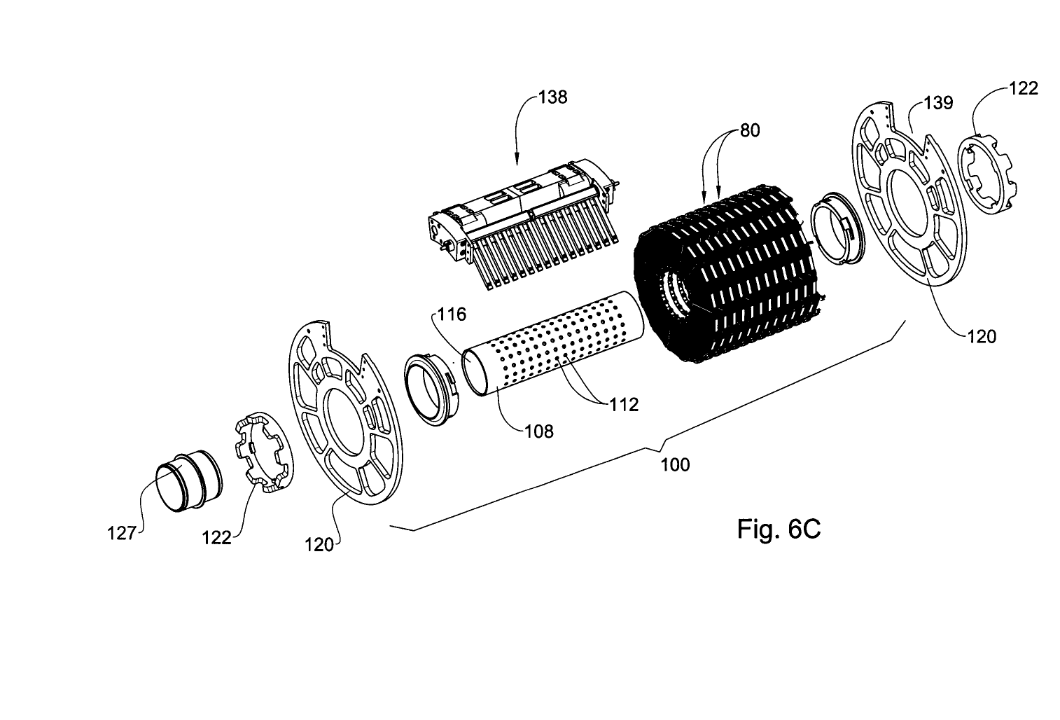

Each of the top filtering surface 32 and bottom filtering surface 34 is substantially flat and comprises a plurality of longitudinal ribs 42 obliquely oriented with respect to the longitudinal axis X and projecting from the respective filtering surface 32 and 34 and defining together a flow path (designated by arrowed lines 90) directing fluid flow towards apertures 48 formed near the front end 36 of the support unit 30. The apertures 48 are through-going over the top and bottom filtering surfaces 32 and 34 and defining together a flow path extending between the ribs 42, into the openings 48 and into a collecting duct 52 (best seen in FIG. 2C). The collecting duct 52 extends coaxial with the longitudinal axis X, from which the flow path extends into a coupler 58 coaxially projecting from the front base 36 and configured for coupling to a central collecting line (constituting part of the filtering assembly; in the form of a filtered fluid collecting duct, namely a cylindrical pipe 108 in FIG. 6A). Some of the longitudinal ribs 42 are interrupted along their length to facilitate fluid flow therebetween. Coupler 58 is typically configured with a groove receiving a sealing O-ring (not shown).

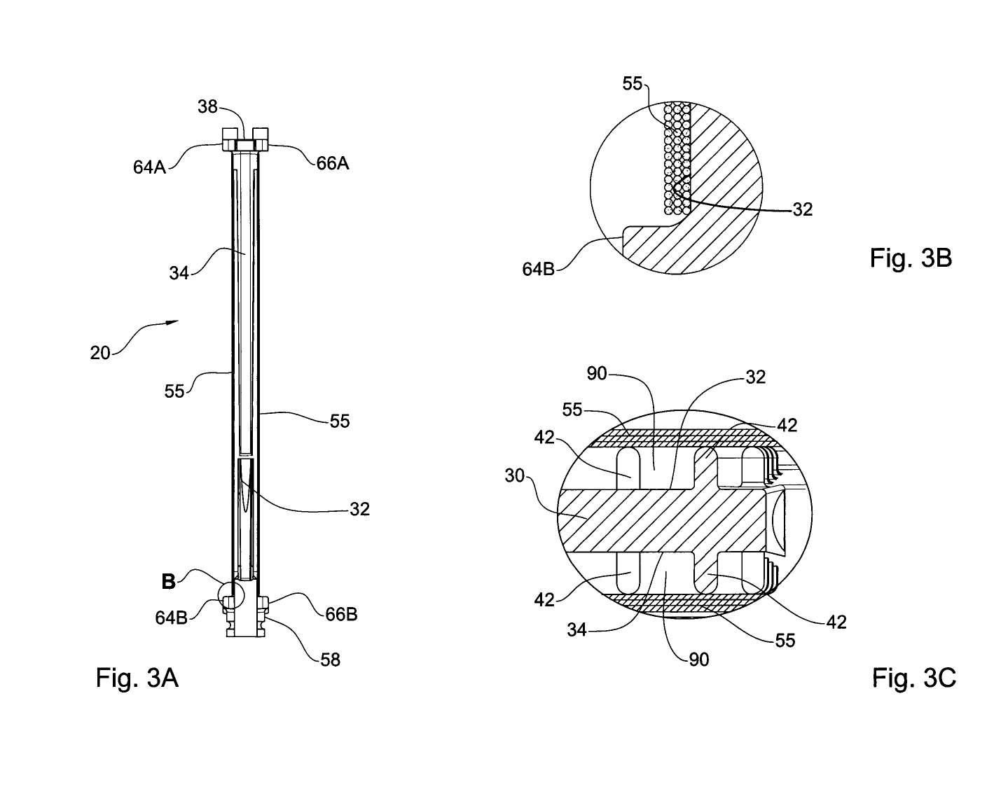

It is further noted that the longitudinal left and right edges 62 of the filtration cassette unit 30 are rounded and further, that the front base 36 and the rear base 38 project beyond said side edges 62 and above the filtering surfaces 32 and 34 as well as above the respective longitudinal ribs 42. This arrangement guaranties that a wrapped (coiled) pack of filtration thread 55 (FIGS. 1A, 3A and 3B) substantially does not project beyond a top-most surface 64A of the rear base 38 or a top-most surface 64B of the front base 36, or beyond a bottom-most surface of the rear base 38 or of a bottom-most surface of the front base 36, respectively, nor beyond a lateral male projection 68A (at the rear base 38) or 68B at the front base 36, or of a lateral female projection 70A at the rear base 38 or 70B at the front base 36, the purpose of said lateral projections to become apparent hereinafter.

Thus, it is appreciated, and as can be seen in FIGS. 1A and 3A and 3B, that the filtration media in the form of a pack of wrapped filtration thread 55, does not exceed any of said boundaries whereby it is protected and thus prevented from damage.

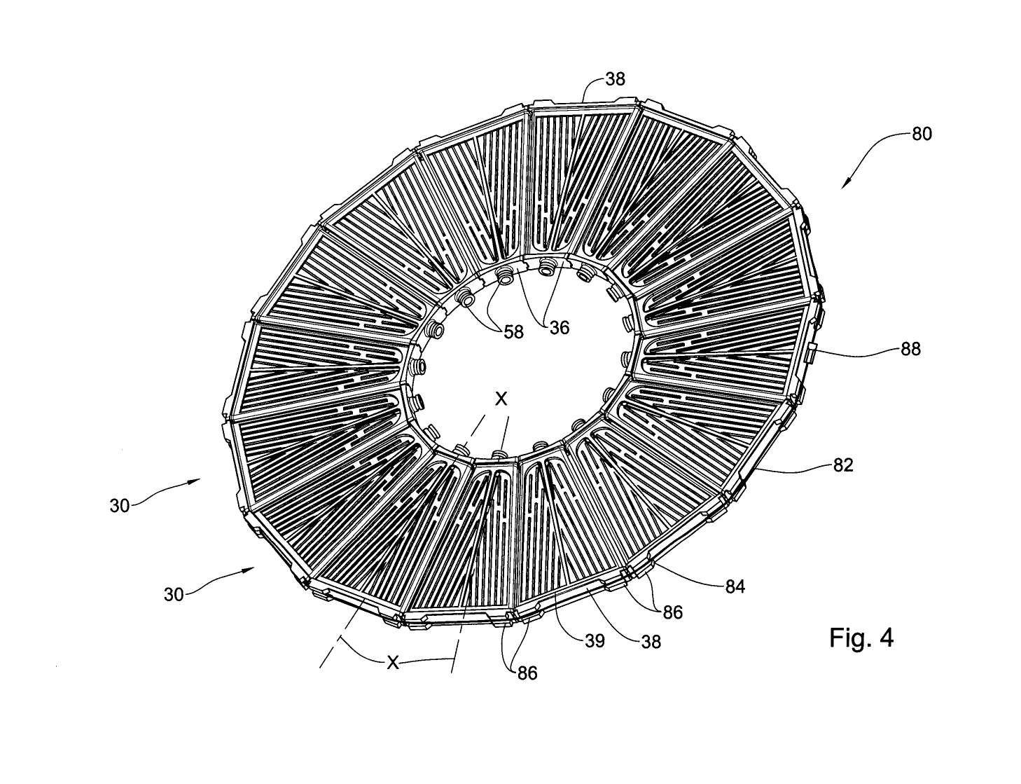

It is further noted that the lateral male projections 68A and 68B are configured for receiving and engagement by corresponding female lateral projections 70A and 70B respectively, as can be seen in the disk-like filtering unit generally designated 80 in FIG. 4, composed of a plurality of planar disposed like filtration cassettes 30. The disk-like filtering unit 80 is maintained in its tight planar configuration of FIG. 4 by means of an arresting portion in the form of a band 82 received within a band-receiving groove 84 formed at the rear base 38 of each filtration cassette 30 (said groove 84 may in fact extend between a pair projections 86 at the rear base) the band 82 may be an elastic band or a band of other nature secured in place by a latch 88.

As illustrated in the drawings, the flow path extends under the filtration media 9i.e. the wrapped filtration thread 55) between the filtering surfaces 32 and 34 along the arrowed lines designated 90. Thus, it is apparent that the flow path extends between the filtering surfaces 32 and 34 and the bottommost layer of the wrapped thread 55, however between the ribs 44 which are configured so as to facilitate fluid flow and direct it towards the apertures 48 (and for that purposes some of the ribs 42 are interrupted at several locations indicated 43).

Whilst in the illustrated example hereinabove the top filtering surface 32 and bottom filtering surface 34 are substantially parallel to one another, other forms are configurable. For example, one or both of the top filtering surface and bottom filtering surface can be concave or convex (not shown). Furthermore, the filtration cassette may have other than trapezoidal shape, e.g. rectangle and the like.

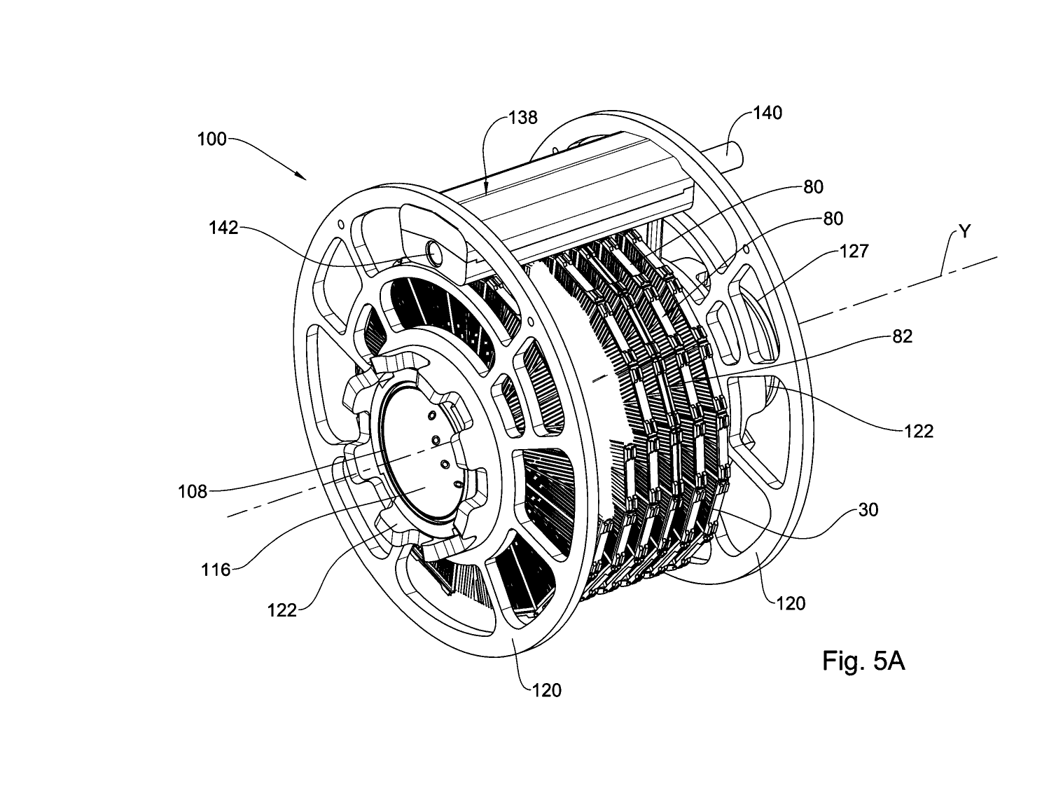

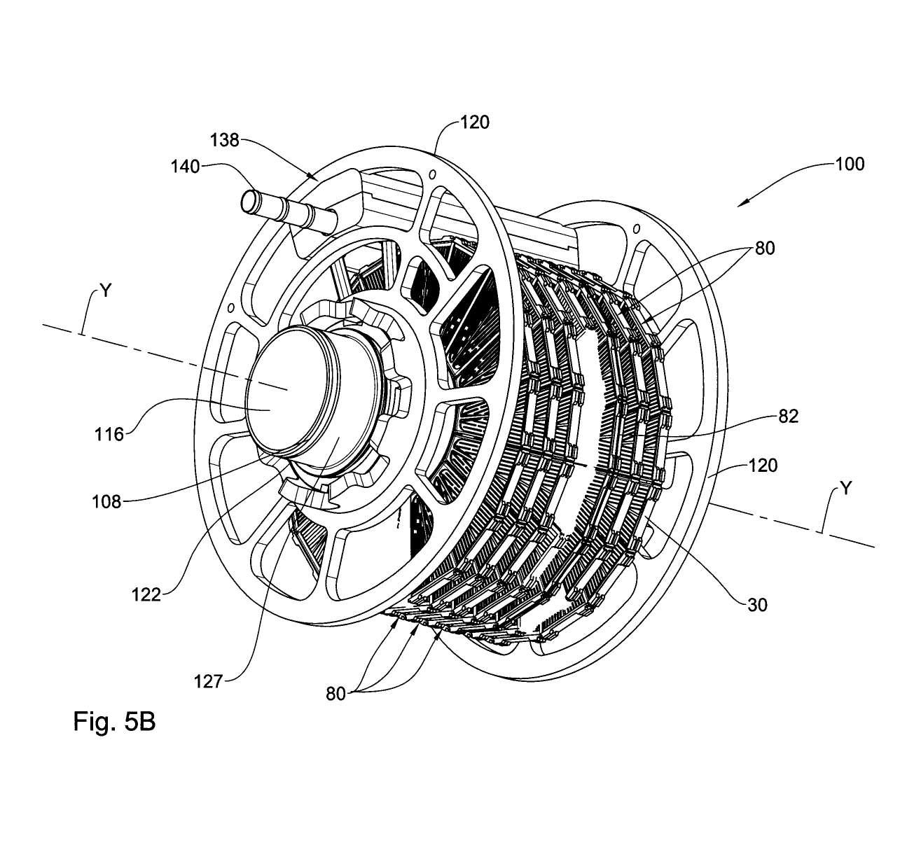

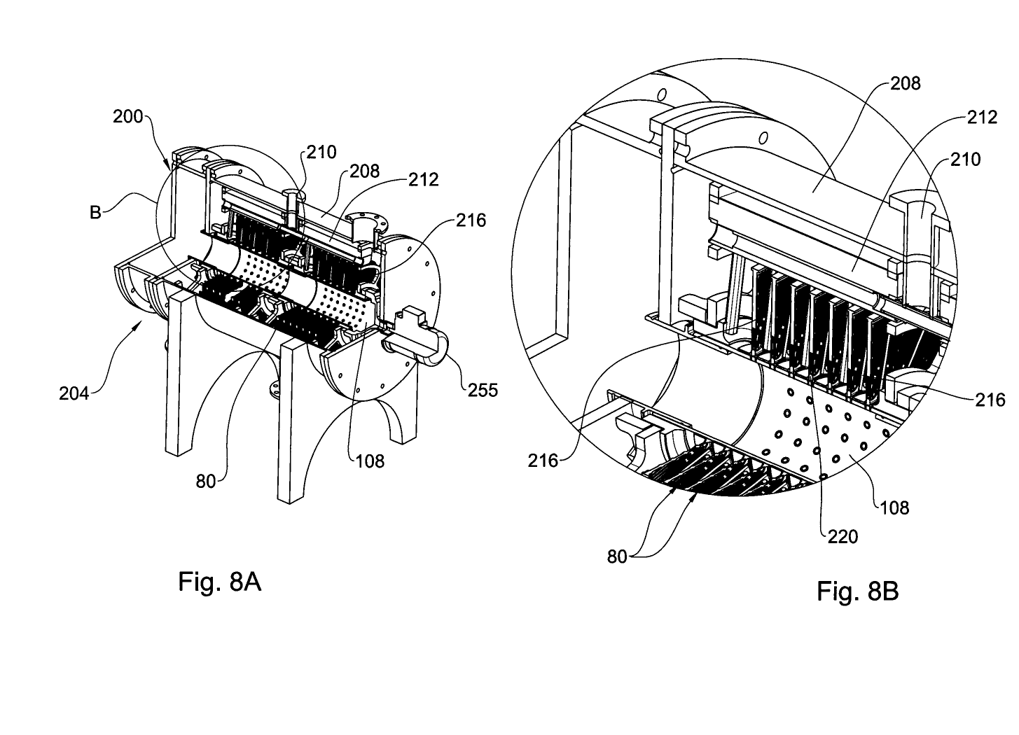

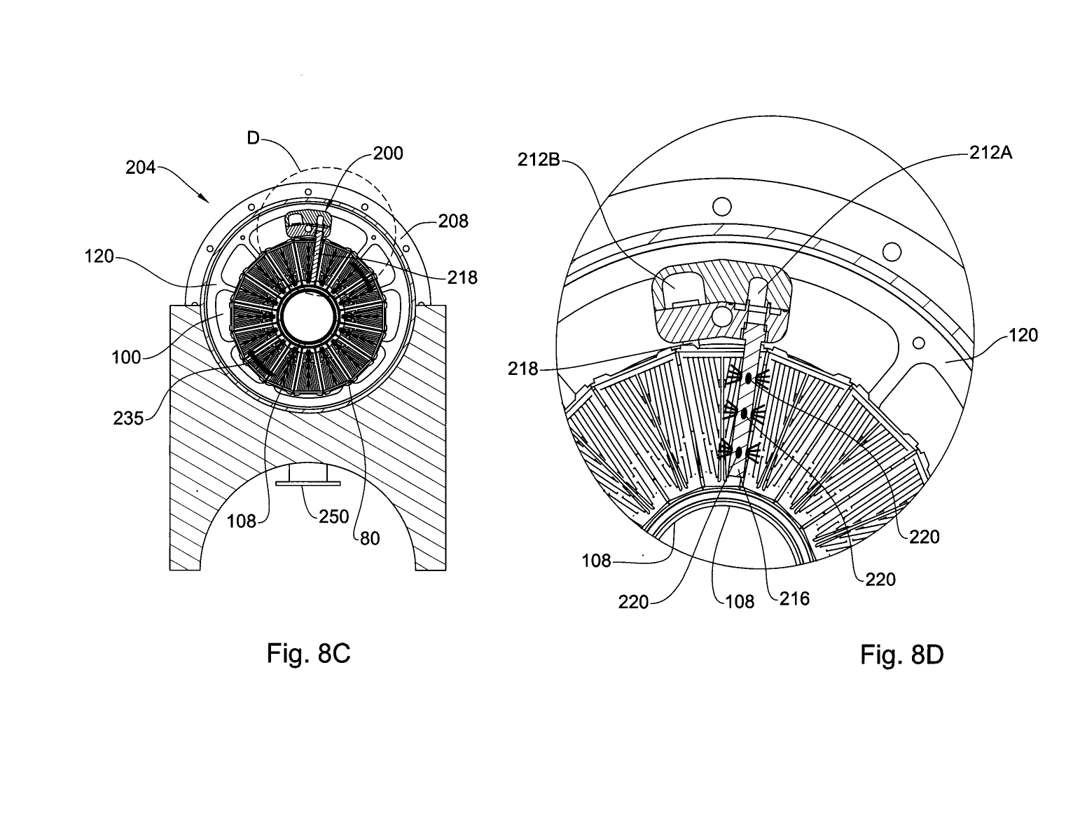

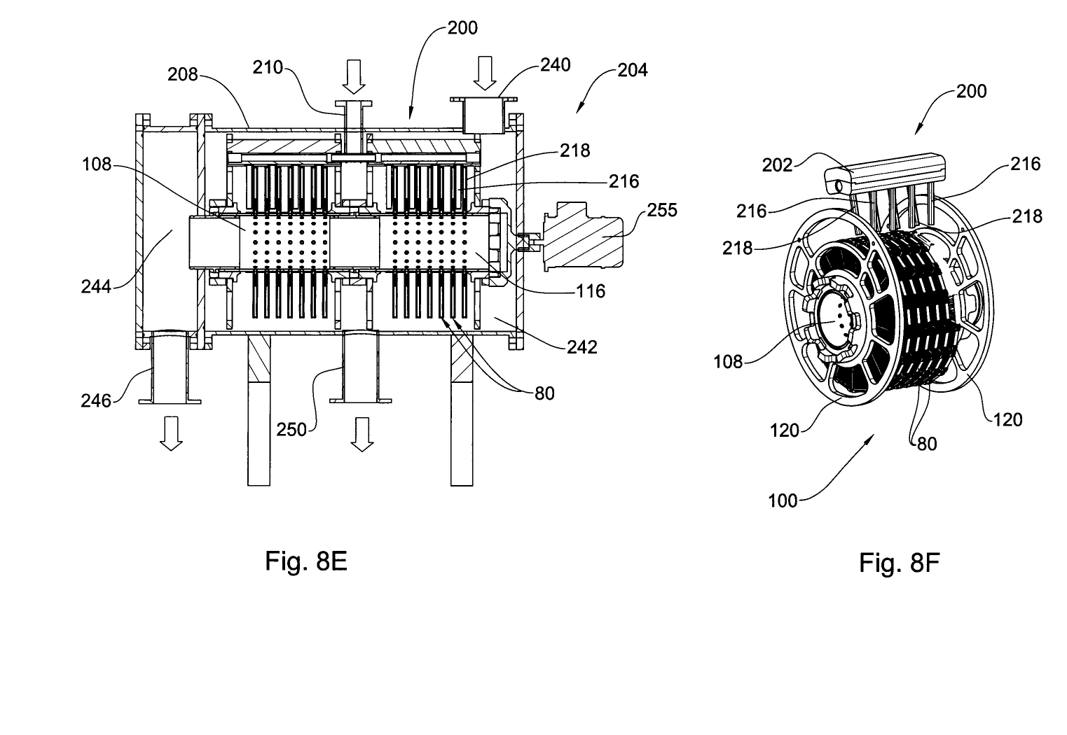

With further attention being now made to FIGS. 5 and 6 of the drawings there is illustrated a filtering system generally designated 100, comprising an array of parallely disposed disk-like filtering units 80 (of the type disclosed hereinafter and discussed in connection with reference to FIG. 4) and used within a filtration assembly, e.g. filtering assembly 204 in FIG. 8.

Filtering system 100 comprises a pack of several disk-like filtering units 80, wherein the disk-like filtering units 80 extend parallel to one another along a common central axis Y, and are secured over a central filtering fluid collecting duct (pipe) 108 which as can be seen in FIG. 6A is formed with a plurality of receptacle openings 112 into which the coupler 58 (FIG. 1A) of each of the filtering cassettes 30 fits, typically by press fit, in a fluid-sealed fashion (an O-ring is fitted over the coupler) and are further secured and prevented from disengaging or displacement by means of the band 82, as discussed in connection with FIG. 4. Thus, each filtration cassette 30 is in flow communication with the inside space 116 of the filtered fluid collecting duct 108 through the respective coupler 58, wherein filtered fluid flows into said space 116 and as will be discussed hereinafter in connection with FIG. 8 is then collected and transferred for use.

The filtering system 100 further comprises a pair of disc-like end plates 120 securely mounted over the central fluid collecting pipe 108 and are pressingly secured by a pair of locking fasteners 122 securely coupled over the collecting pipe 108.

The end plates 120 further support a rinsing mechanism generally designated 138 (removed from its seat 139 in FIG. 6A; said rinsing mechanism 138 being one of two examples as will be discussed hereinafter in further detail). It is also noted that the rinsing mechanism 138 is configured with a rinsing fluid inlet port 140.

The filtering system 100 can be a single item within a filtration assembly, or it can be part of an array of like filtering units wherein such filtering units coaxially coextend (along the Y axis) with fluid flow extending between the respective filtered fluid collecting ducts 108 and also between neighboring rinsing mechanisms 138 through pipe segments 140 extending into a respective coupling end 142 at an opposed end thereof (FIG. 5A). For coupling to neighboring coaxial filtering units, the fluid collecting ducts 108 may project beyond one or both of the end supports 120, or an extension pipe segment 127 may be coupled thereto via fasteners 122 (see FIG. 6C). however, a plurality of filtration system can be configured also in parallel relation, with suitable collecting pipes extending therebetween (not shown).

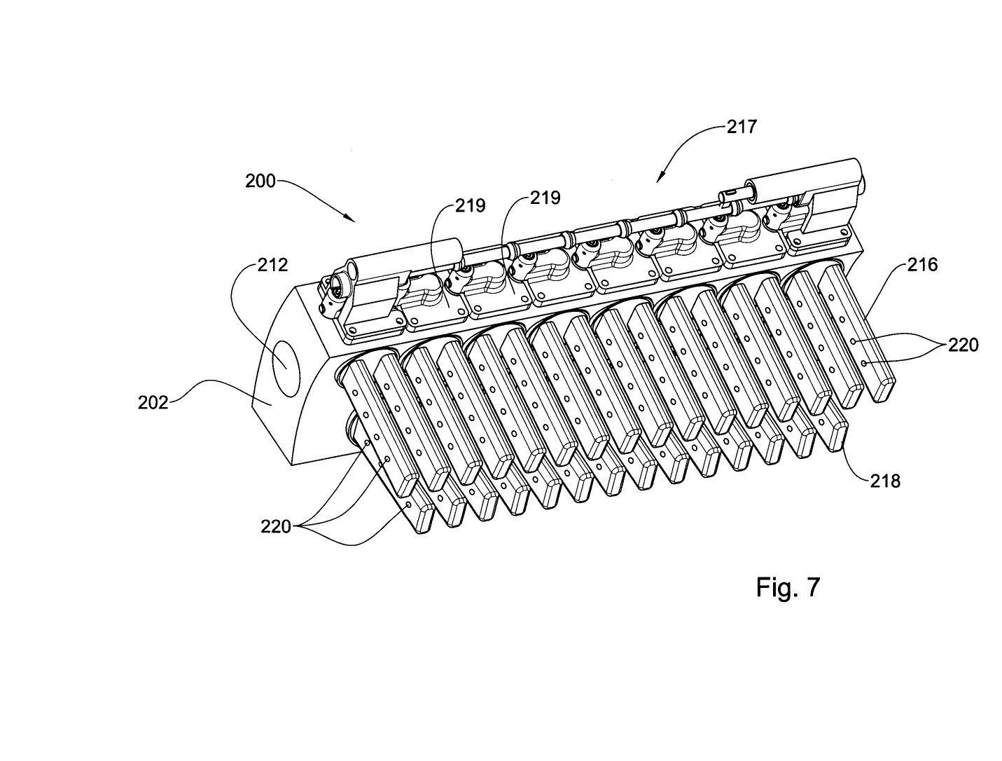

Owing to the nature of the filtering system 100, namely its assembly of a plurality of adjoining disk-like filtering units 80, there is the need to provide a cleaning mechanism competent for rinsing the filtering media, namely the coiled threads in between the disk constructions. For that purpose, a rinsing mechanism is provided, as illustrated in FIGS. 5 and 6. A first example of a rinsing mechanism will be discussed hereinafter with reference to FIGS. 7 and 8 of the drawings and generally designated 200.

Rinsing mechanism 200 comprises a solid support block 202 secured to the housing 208 of the filtering system 204 (or to the end plates 120) and comprises a rinsing fluid inlet port 210 extending from the housing 208 and into a rinsing fluid distribution line 212, from which radially extend a plurality of jet emitting arms 216 and 218 (their configuration best seen in FIG. 7), arranged in two offset rows such that the arms 216 of one row alternate the arms 218 of the other row, wherein the arms are so mounted that their free ends extend towards the filtered fluid central collecting pipe 108 of the filtering system, at a substantial radial orientation. Each of the jet emitting arms 216 and 218 is configured with a plurality of jet emitting nozzles 220 facing the filtration cassettes 20 of the disk-like filtering assemblies 80 (i.e. configured for emitting rinsing fluid in the axial direction). The distribution of the jet emitting nozzles 220 is configured for covering substantially the entire surface of the filtering media.

In the particular example the rinsing mechanism 200 is a static mechanism wherein the disk-like filtering units 80, mounted over the central collecting pipe 108 are rotatable (arrow 235 in FIG. 8C) by motor 255, whereby rotating the filtering unit 100 whilst applying a rinsing fluid through the jet emitting arms 216 and 218 results in rinsing/cleaning of the filtering cassettes 30.

Notable, rotation of the disc-like array of disc-like filtering units is facilitated by any type of motion generating mechanism, such as an electric motor, a hydraulic motor, pneumatic actuators, etc., and combinations thereof.

In the illustration of FIG. 7 the housing 202 comprises a single rinsing fluid distribution line 212 whilst in the illustrations of FIGS. 8A to 8F there are provided two fluid distribution lines 212A and 212B, each associated with a row of arms 216 and 218 respectively, however both are in fluid communication with the rinsing fluid's inlet port 210.

The rinsing mechanism 200 of FIG. 7 is further configured with a controlled rinsing fluid distribution system 217 with a plurality of flow control gates 219, each being in flow communication with the rinsing fluid distribution line 212 and with a respective rinsing arm 216 and 218, whereby a hydraulic/pneumatic/electric or combined controller opens/closes the control gates 219 to facilitate rinsing fluid to the respective rinsing arm.

With reference to FIG. 8E there is illustrated the filtration assembly 204 configured with a raw fluid inlet port 240 connectable to a supply of raw fluid (not shown) and extending into the inner filter space 242. The plurality of disk-like filtering units 80 are fitted over the fluid collecting pipe 108 in a fluid tight manner, wherein said pipe 108 extends into a filtered fluid collecting chamber 244 configured with a filtered fluid outlet port 246 connected to a consumption pipe (not shown). The housing 208 of the filtration assembly 204 is further fitted with a rinsing fluid inlet port 210, which as explained hereinabove, is in flow communication with the rinsing fluid distributor line 212, which in turn is in flow communication with the plurality of jet emitting arms 216 and 218 alternatingly distributed between neighboring disk-like filtering assemblies 80. The central space 242 of the filtering system 204 is further configured with a rinsing/flushing fluid outlet port 250.

The arrangement is such that during a filtering process the rinsing fluid inlet port 210 and the flushing outlet port 250 are shut whilst raw fluid enters the filtration assembly through inlet port 240, flows through the plurality of filtration segment 20 of the disk-like filtering units 80, into the space 116 of the collecting tube 108 and then into chamber 244 from which the filtered fluid flows out for consumption through outlet port 246.

When it is now required to rinse the filtration assembly 204, the inlet port 240 and the filtered fluid outlet port 246 are shut whilst a rinsing fluid is pressurized through the rinsing fluid inlet port 210, resulting in rinsing fluid jets emitting through the nozzles 220 (configured on arms 216 and 218) directed towards the coiled filtering threads and simultaneously, the electric motor 255 is operated, giving rise to rotation of the filtering unit (namely the collecting pipe 108 with the associated disk-like filtering assemblies 80). It is however appreciated that rather than electric motor 255 hydraulic or pneumonic rotating arrangements may be provided.

The rinsing fluid together with any dirt and remainders are then drained from the filter space 242 through outlet port 250 either to the environment or to a sewage line or recycling facility.

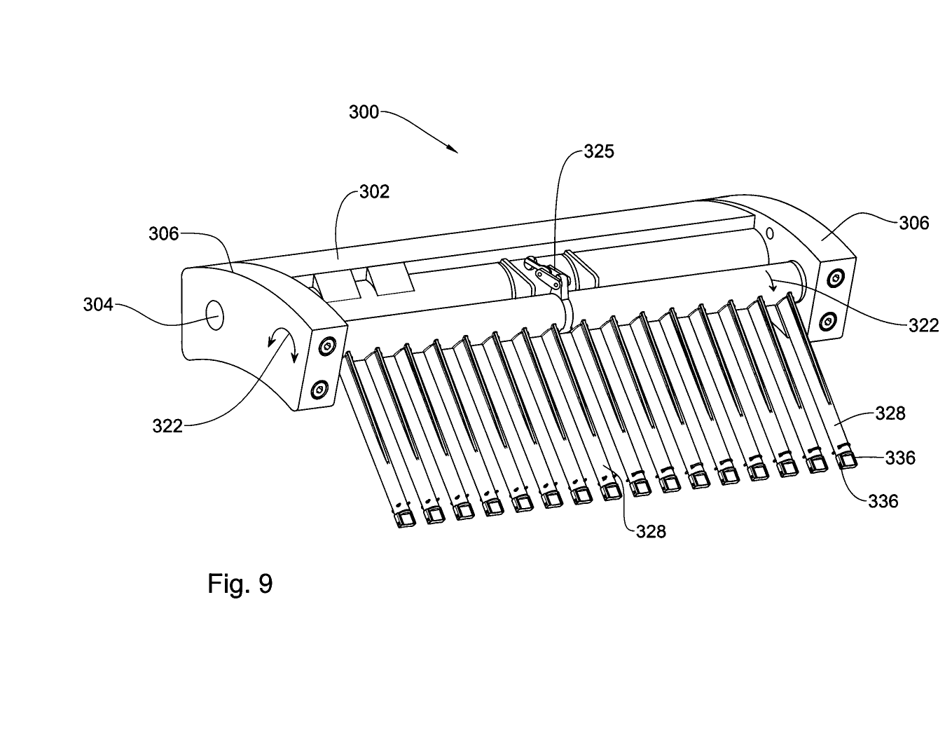

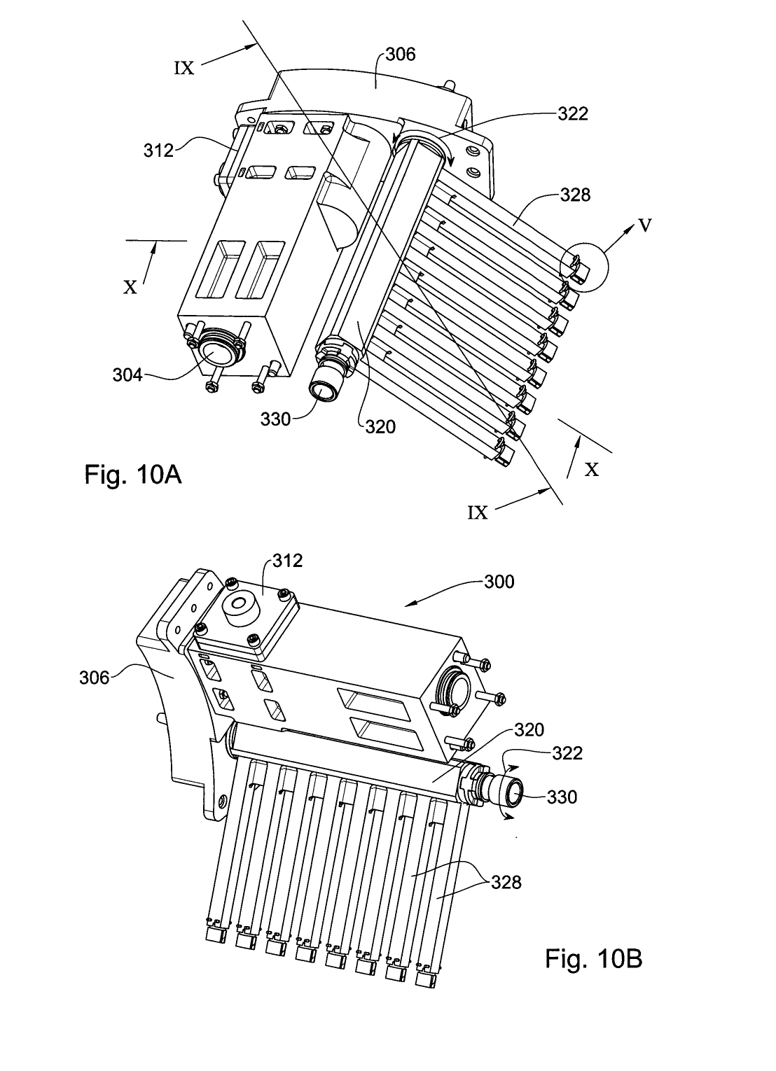

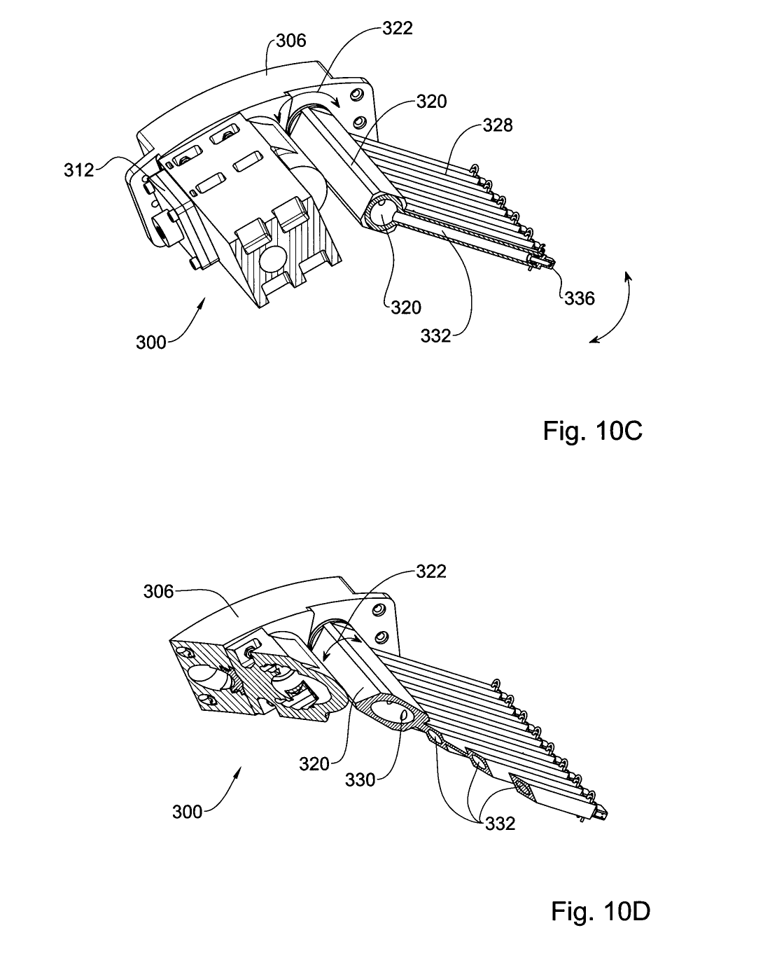

Turning now to the example illustrated in FIGS. 9 and 10 there is illustrated a rinsing mechanism generally designated 300 according to a different example, comprising a rinsing mechanism housing 302 configured for securing to the end supports 120 (FIGS. 5 and 6), said housing configured with a rinsing fluid main line 304 extending between two end plates 306 (only one of which seen in FIG. 10) and further configured with a hydraulic motor generally designated 312 configured for imparting a rinsing fluid distribution pipe 320 with reciprocal pivotal motion in direction of arrowed line 322. It is appreciated that the hydraulic motor 312 may be articulated to the rinsing fluid distribution pipe 320 through the end piece 306 or by a reciprocating link designated 325 (FIG. 9). Furthermore, the rinsing fluid distribution pipe may be reciprocated by any of a hydraulic, pneumatic or electric motor, or a combination thereof.

Integrally extending from the distribution pipe 320 there is a plurality of jet emitting arms 328 being in flow communication with the space 330 of the distribution pipe 320. Each of said arms is configured with an internal lumen 332 terminating at a jet emitting nozzle 336. The arrangement is such that the arms are pivotally disposed near a periphery of the filtration cassettes and are configured for reciprocal pivotal displacement (in a turntable-arm resembling fashion). The length of each of the arms 328 is substantially the length of a filtration segment 20 such that when the jet emitting arms 328 are reciprocally displaceable (about arrowed line 322) between an innermost position where they reach to the collection pipe 108, and an outermost position at the distal end of the filtration segment 20, they rinse substantially the entire surface of the disc-like filtering assemblies.

In operation, a rinsing fluid is applied through the supply line 304 to thereby operate the reciprocating hydraulic motor 312 and rinsing fluid is then emitted into the pipe 330 and through lumens 332 and then out through the nozzles 336 upon imparting pivotal reciprocal displacement thereto.

Simultaneously, an electric/hydraulic/pneumonic motor rotates the filtering unit 100, resulting in a fluid jet emitted against the coiled filtering threads 55 of the filtration segment 20 similar to the general concept as discussed in connection with reference to FIG. 8D.

While there have been shown several examples of the disclosed subject matter, it is to be understood that many changes may be made therein without departing from the spirit of the present disclosed subject matter, mutatis mutandis.

1.-22. (canceled)

23. A filtration cassette having a rigid body configured for externally supporting a filtration media disposed thereover and having at least one filtering surface configured with a flow path facilitating filtered fluid flow from a space extending between the filtration media and the filtering surface, and extending towards an outlet terminal.

24. The filtration cassette according to claim 23, wherein the body is a flat, trapezoidal structure, such that an array of like filtration cassettes can be assembled into a near-to-circular, disc-like filtering assembly.

25. The filtration cassette according to claim 23, wherein the filtering surface is configured with a plurality of ribs projecting from the filtering surface for supporting the filtration media and facilitating fluid flow through the flow path, over the surface and between the plurality of ribs.

26. The filtration cassette according to claim 23, wherein the filtering surface is configured with a plurality of ribs projecting from the filtering surface for supporting the filtration media and facilitating fluid flow through the flow path, over the surface and between the plurality of ribs and wherein the flow path extends over the filtering surface of the filtration cassette and then extends through the filtering surface into a collecting duct within the rigid body and further towards the outlet terminal.

27. The filtration cassette according to claim 23, wherein the body is configured at respective radial innermost and outermost ends thereof, with a filtration media support laterally projecting from the filtering surface.

28. The filtration cassette according to claim 23, wherein the filtering surface is configured with a concaved cross-section.

29. The filtration cassette according to claim 23, configured for assembly in a radial setup to a filtered fluid collecting duct, wherein coupling to the collecting duct is facilitated through a fluid-tight coupler of the outlet terminal.

30. The filtration cassette according to claim 23, configured at a distal end thereof with an arresting portion for securing to neighboring filtration cassettes.

31. The filtration cassette according to claim 23, configured at a distal end thereof with an arresting portion for securing to neighboring filtration cassette and wherein the arresting portion is in the form of a band-receiving groove configured at a rear end of the filtration cassette.

32. A filtration segment comprising a filtration cassette having a rigid body externally supporting a filtration media disposed thereover and having at least one filtering surface configured with a flow path facilitating filtered fluid flow from a space extending between the filtration media and the filtering surface, and extending towards an outlet terminal.

33. The filtration segment according to claim 32, wherein the filtration media is a filtration thread tensionally coiled over the filtration cassette at a multi-layered and tight configuration.

34. The filtration segment according to claim 32, wherein the filtration media is a substantially continuous filtration thread tensionally coiled over the filtration cassette at a multi-layered and tight configuration.

35. The filtration segment according to claim 32, wherein the filtration media is a filtration thread tensionally coiled over the filtration cassette at a multi-layered and tight configuration, and wherein the tension of the coiled thread varies about one or both the longitudinal axis of the filtration cassette and between wrapping layers.

36. The filtration segment according to claim 32, wherein the filtration media is a filtration thread tensionally coiled over the filtration cassette at a multi-layered and tight configuration and wherein the filtration thread is continuous or not, with an altering thickness.

37. The filtration segment according to claim 32, wherein the filtration media is a filtration thread tensionally coiled over the filtration cassette at a multi-layered and tight configuration and wherein the filtration thread is wrapped about a longitudinal axis of the filtration cassette.

38. The filtration segment according to claim 32, configured for assembly in a radial setup to a filtered fluid collecting duct.

39. A filtering system configured with an array of filtration units, each composed of a plurality of filtration segments comprising a filtration cassette having a rigid body externally supporting a filtration media disposed thereover and having at least one filtering surface configured with a flow path facilitating filtered fluid flow from a space extending between the filtration media and the filtering surface, and extending towards an outlet terminal, said filtration segments being coupled into a filtered fluid collecting duct of the filtering system for providing filtered fluid.

40. The filtering system according to claim 39, comprising a rinsing mechanism for rinsing the filtration cassettes, said rinsing mechanism comprising a plurality of parallely extending fluid jet emitting arms, each configured with at least one jet emitting nozzle juxtaposing and facing a filtration media of a filtration cassettes of the disk-like filtering units, and configured for selectively emitting a jet of rinsing fluid over the filtration media.

41. The filtering system according to claim 39, comprising a rinsing mechanism for rinsing the filtration cassettes, said rinsing mechanism comprising a plurality of parallely extending fluid jet emitting arms, each configured with at least one jet emitting nozzle juxtaposing and facing a filtration media of a filtration cassettes of the disk-like filtering units, and configured for selectively emitting a jet of rinsing fluid over the filtration media and, wherein the rinsing mechanism comprises at least one fluid jet emitting arm juxtaposed and facing the filtration media of the filtration units, and configured for selectively emitting a jet of rinsing fluid over the filtration media, the at least one jet emitting arm being configured with an array of jet nozzles disposed along its length and facing the filtration media, and whereby the disc-like filtering units are rotationally displaceable about a central axis thereof, whereby a rinsing fluid jet is applied substantially over the entire surface of the filtration media as they rotate with respect to the jet emitting arms.

42. The filtering system according to claim 39, comprising a rinsing mechanism for rinsing the filtration cassettes, said rinsing mechanism comprising a plurality of parallely extending fluid jet emitting arms, each configured with at least one jet emitting nozzle juxtaposing and facing a filtration media of a filtration cassettes of the disk-like filtering units, and configured for selectively emitting a jet of rinsing fluid over the filtration media wherein the rinsing mechanism comprises one or more jet emitting arms, each fitted with one or more jet nozzles near a distal end of the one or more arms and wherein the arms are configured for reciprocal pivotal displacement in a turntable-arm resembling fashion over the filtration media of the disc-like filtering units, and whereby the disc-like filtering units are rotationally displaceable about a central axis thereof, whereby a rinsing fluid let emitted from the jet nozzles substantially rinses an entire face of a filtration segment.
